(19) United States
(12) Patent Application Publication
(10) Pub. No.: US 2011/0049899 A1
(43) Pub. Date: Mar. 3, 2011

(54) AIR OR LIQUID-DRIVEN ALTERNATOR AND ELECTRICAL GENERATOR

(76) Inventor: COLIN HOFFMAN, Hamburg, NY (US)

(21) Appl. No.: 12/548,360

(22) Filed: Aug. 26, 2009

(51) Int. Cl. H02K 7/18

(52) U.S. Cl. 290/54

(57) ABSTRACT

An air or liquid-driven alternator and electrical generator includes: a closed-loop circuit; an inlet that allows a fluid to be introduced into the closed-loop circuit; a first fan, powered by the motor, that moves the fluid through the closed-loop circuit; and a generator having a second fan that is spun by the movement of the fluid so as to generate electricity.

### BACKGROUND OF THE INVENTION

The present invention generally relates to electrical generators, and more specifically, to an air or liquid-driven alternator and electrical generator.

It might be desirable to have a system that operates using compressed air, includes an air pressure valve, or is integrated into an already functioning automotive system. The system might have a closed-loop system. It might have an externally mounted electric motor driving an internal fan or impeller.

As the need for electrically or partially electrically propelled vehicles rises, so too does the need to conserve electricity within these vehicles. Although there are patents relating to this field, currently no such system exists on the market. Such a system would ideally work as a means for a vehicle, such as an automobile, to use less energy to propel its occupants. These vehicles of course use electric motors in some fashion, but the electric motors in these vehicles serve only to use electricity. There is currently no means by which an electric motor can regenerate electricity so as to recharge the energy source the electric motor is powered from, thereby using less energy.

As can be seen, there is a need for a new electrical generator.

### SUMMARY OF THE INVENTION

In one aspect of the present invention, a device for generating electricity utilizing a motor includes: a closed-loop circuit; an inlet that allows a fluid to be introduced into the closed-loop circuit; a first fan, powered by the motor, that moves the fluid through the closed-loop circuit; and a generator having a second fan that is spun by the movement of the fluid so as to generate electricity.

In another aspect of the present invention, a device for generating electricity utilizing a motor includes: a closed-loop circuit; an inlet that allows a fluid to be introduced into the closed-loop circuit, the fluid selected from the group consisting of: compressed air and fluid; a first fan, powered by the motor, that moves the fluid through the closed-loop circuit; and a generator having a second fan and a winding; wherein the second fan is spun by the movement of the fluid so that the winding and the second fan cooperate to generate electricity.

In yet another aspect of the present invention, a method of generating electricity utilizing a motor includes: providing a closed-loop circuit; introducing a fluid into the closed-loop circuit; powering a first fan with the motor so as to move the fluid through the closed-loop circuit; and spinning a second fan of a generator by the movement of the fluid so as to generate electricity.

These and other features, aspects and advantages of the present invention will become better understood with reference to the following drawings, description and claims.

### BRIEF DESCRIPTION OF THE DRAWINGS

FIG. 1 depicts an embodiment of the present invention; and

FIG. 2 depicts an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides an air driven alternator where an electric motor spins a fan or turbine in an enclosed loop of compressed air or viscous fluid. The compressed air or viscous fluid then spins a generator.

An embodiment of the invention is intended to generate electricity so as to lessen the total energy used by an electric motor, such as in an electric or hybrid vehicle.

An embodiment of the invention is an alternator that uses an electric motor such as those used in an electric or hybrid car. The motor spins a fan or impeller in an enclosed circuit of compressed air or viscous fluid, and forces the air or fluid to spin a generator, thus generating electricity.

An embodiment of the present invention 10 may include the following elements:
Electric motor 12—provides power to the system.
Fan or impeller 14—spun by the electric motor 12 and moves compressed air or viscous liquid through a closed circuit.
Generator 16—spun by the compressed air or viscous liquid. The generator 16 includes a fan 18 and a winding 20.
Closed loop case 22—houses the fan or impeller 14 and the compressed air or viscous liquid. An alternate embodiment 30 may also house a second generator 26.
Air pressure valve 24—used to fill the circuit with compressed air. Alternately it would be used to fill the circuit with a viscous liquid or other fluid material.

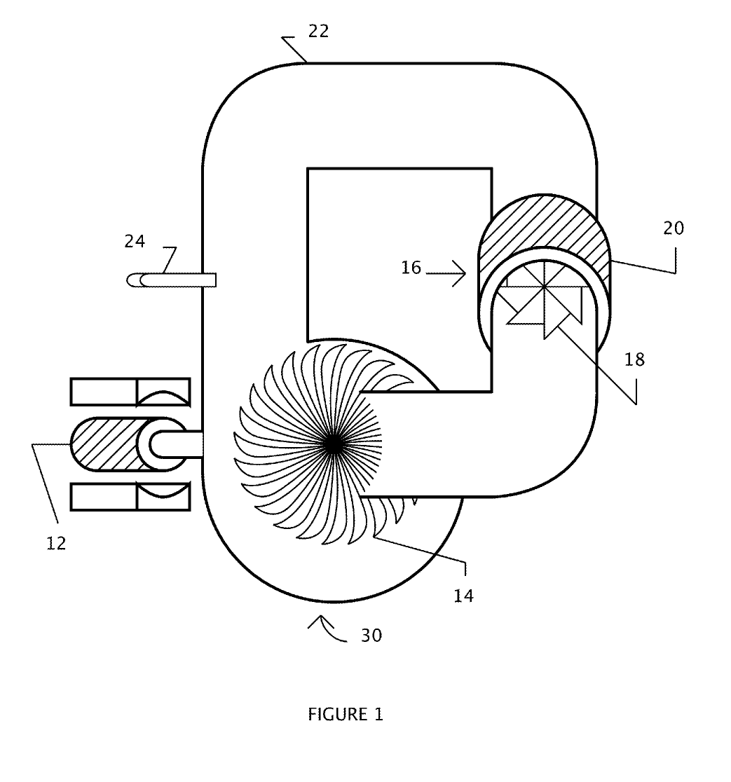

As depicted in the embodiment of FIG. 1, an embodiment of the present invention 10 includes an electric motor 12, housing 22 for the enclosed loop circuit, and generator 16, which includes a winding 20 and a fan 18. The winding 20 may be located in the interior or exterior of the housing for the enclosed loop circuit 22.

The closed-loop case 22 encases the impeller 14, generator 16, and compressed air/viscous liquid. The electric motor 12 spins the impeller 14, which in turn moves the compressed air/liquid through the circuit. The compressed air/liquid spins the generator 16, which produces electricity. The compressed air/liquid then moves back to the impeller 14 so that it can move through the circuit again.

In other embodiments, compressed air could be interchanged with liquid and the fans would work as impellers. Compressed air could range anywhere from 40 psi to 100 psi. A lower pressure would mean better safety for passengers in a vehicle, but would ultimately compromise the power generated by the master impeller. This could be exchanged however for a liquid such as water or vegetable oil. In a particular embodiment the housing could be filled with transmission fluid. Thus the housing, electric motor, and transmission to which the electric motor is mounted could all be sealed as one unit. Transmission fluid would act not only as a force for spinning the secondary generator but also as a lubricant for the electric motor. This would virtually eliminate the need to repair an eventual leak from the housing to the electric motor or from the electric motor to the transmission, ultimately improving reliability. Various viscosities could be used, but a 75w90 rated gear oil would be preferred.

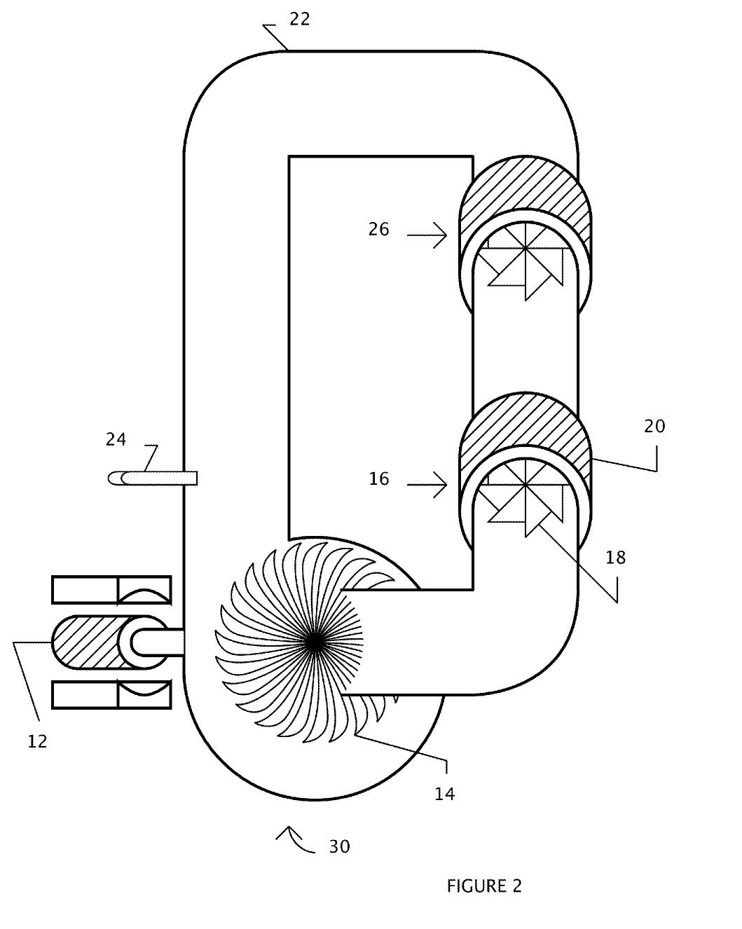

As depicted in FIG. 2, an alternate embodiment 30 includes a second generator 26 to generate even more electricity. The generators 16 and 26 generate electricity, which can be used to regenerate the battery or batteries used to power an electric or hybrid car.

To make an embodiment of the invention, the closed-loop circuit 22 could be cast in two halves. The primary impeller 14 would be connected to the electric motor 12 using the motor's own winding. The generator units 16 and 26 could be assembled separately and placed in one of the halves of the closed-loop circuit. The electric motor/impeller unit 14 would be inserted as well. Then the two halves of the circuit would be closed up and welded so that the system would be air-tight. One of the halves would have an air compression valve 24 to compress the air. Alternately, the circuit would have a valve for inserting a viscous liquid.

An embodiment of the invention would be housed in an electric or hybrid vehicle preferably under the hood. As the electric motor spun the generator would regenerate the battery. If compressed air were to lose pressure one could open the hood and fill it like it was a tire.

The system could alternately be used as a serpentine belt, where the air or liquid would spin fans or impellers that worked power steering pumps or air conditioning units.

It should be understood, of course, that the foregoing relates to exemplary embodiments of the invention and that modifications may be made without departing from the spirit and scope of the invention as set forth in the following claims.

We claim:

1. A device for generating electricity utilizing a motor, comprising:
a closed-loop circuit;
an inlet that allows a fluid to be introduced into the closed-loop circuit;
a first fan, powered by the motor, that moves the fluid through the closed-loop circuit; and
a generator having a second fan that is spun by the movement of the fluid so as to generate electricity.

2. The device of claim 1, wherein the fluid is either compressed air or a viscous liquid.

3. The device of claim 1, further comprising:
a winding around the second fan;
wherein, when the second fan is spun, the winding and the second fan cooperate to produce the electricity.

4. The device of claim 3, wherein:
the closed-loop circuit is enclosed within a housing;
the first fan is located inside the housing;
the second fan is located inside the housing; and
the winding around the second fan is located outside the housing.

5. The device of claim 1, further comprising:
a second generator having a third fan, the third fan spun by the movement of the fluid so that the second generator produces further electricity.

6. The device of claim 1, wherein the motor is the motor of an automobile and the electricity is provided to a battery of the automobile.

7. A device for generating electricity utilizing a motor, comprising:
a closed-loop circuit;
an inlet that allows a fluid to be introduced into the closed-loop circuit, the fluid selected from the group consisting of: compressed air and viscous liquid;
a first fan, powered by the motor, that moves the fluid through the closed-loop circuit; and
a generator having a second fan and a winding;
wherein the second fan is spun by the movement of the fluid so that the winding and the second fan cooperate to generate electricity.

8. A method of generating electricity utilizing a motor, comprising:
providing a closed-loop circuit;
introducing a fluid into the closed-loop circuit;
powering a first fan with the motor so as to move the fluid through the closed-loop circuit; and
spinning a second fan of a generator by the movement of the fluid so as to generate electricity.

9. The method of claim 8 wherein the fluid is compressed air and the compressed air is introduced into the closed-loop circuit via an inlet.

10. The method of claim 8 further comprising:
adding the closed-loop circuit to an automobile so as to utilize the motor of the automobile to generate electricity.
